(19) United States
(12) Patent Application Publication
(10) Pub. No.: US 2008/0168907 A1
(43) Pub. Date: Jul. 17, 2008

(54) Automatism spumescence equipment of milk

(75) Inventors: Chunmeng Shen, Xiamen (CN); Weifeng Jiang, Xiamen (CN)

Correspondence Address: GREER, BURNS & CRAIN, 300 S WACKER DR, 25TH FLOOR, CHICAGO, IL, 60606, US

(73) Assignee: TSANN KUEN (CHINA) ENTERPRISE CO., LTD.

(21) Appl. No.: 11/827,599

(22) Filed: Jul. 12, 2007

(30) Foreign Application Priority Data
Jul. 13, 2006 (CN) 200620086981.7

(51) Int. Cl. A47J 31/00

(52) U.S. Cl. 99/294

(57) ABSTRACT

Automatism spumescence equipment of milk, including: a main body having a sparkle cavity; two ends of the sparkle cavity respectively have a steam inlet and a steam outlet; an impeller is located inside the sparkle cavity; stress surfaces of the fan blades of the impeller face the steam inlet; a lateral wall of the steam inlet has a milk inlet; the milk inlet connects with a tube which can extract milk from a milk container.

### TECHNICAL FIELD

The present utility model relates to coffee appliance, concretely to automatism spumescence equipment of milk.

### BACKGROUND OF THE TECHNOLOGY

The cream floating at the surface of espresso can be fresh butter or milk; in using milk, it froths by milk spumescence equipment. The cream froth of cappuccino or latte is produced by milk spumescence equipment.

A simple spumescence equipment is manual cream froth equipment, comprising a cup container with a lid; the cup container contains a sliding bar which can slide up and down along the cup body; the sliding bar has a hand-hold part at its outer end and a gauze filter matched with the inner diameter at its inner end. In using, sliding the sliding bar up and down to make the gauze filter pumps in the milk to get cream froth. It cannot assure the quality of the cream froth by this manual cream froth equipment and it operates complexly.

Another automatism spumescence equipment of milk is utilizing the steam of high pressure produced by coffee machine frothing the milk to get milk froth, which has a bad effect; other automatism spumescence equipments of milk adopt motor driving impeller to get milk froth, which will increase the cost of spumescence equipment.

### The Content of the Utility Model

The present utility model provides an automatism spumescence equipment of milk to avoid the disadvantages of existing automatism spumescence equipments of milk.

The present utility model adopts technical proposal as follows: automatism spumescence equipment of milk, comprising a main body having a sparkle cavity; two ends of the sparkle cavity respectively have a steam inlet and a steam outlet; an impeller locates inside of the sparkle cavity; the stress surfaces of the fan blades of the impeller are towards the steam inlet; the lateral wall of the steam inlet has a milk inlet; the milk inlet connects with a tube which can extract milk from milk container. When steam of high pressure comes into from the steam inlet, the milk is extracted from the tube and comes into the sparkle cavity with steam of high pressure through milk inlet and steam inlet; the steam of high pressure drives impellers wheel; milk comes into being milk froth of minuteness under the effect of the steam of high pressure and impellers and bursts forth from steam outlet.

The milk passage of the milk inlet has a knob which can turn outside of the main body; the knob has a through hole through the milk passage. It can adjust the quantity of inhalational milk by circumgyrating the knob to make the through hole of knob have an angle with the milk passage.

The lateral wall of the milk passage of milk inlet has a breather hole; the breather hole has a breather valve; the valve body of the breather valve has a lengthways hole; one end of the lengthways. hole connects with the breather hole; two sides of another end of the lengthways hole connects with outside by two through holes. Air can come into from the breather valve and mixes with milk and steam to make the quality of milk froth better.

The joint of the steam inlet and the sparkle cavity forms a taper inlet, whose external diameter is bigger than inner diameter so that steam and milk spout into the sparkle cavity with some pressure.

Said main body comprises a body and a body base; the body base is embedded into the body; the room surrounded by the body and the body base forms said sparkle cavity; the rotor shaft of said impeller is rotatable sandwiched between the body and the body base; a body lid is embedded into the body base; said steam outlet forms on the body lid.

Comparing with existing technology, the present utility model has virtues as follows: firstly, milk is churned up by the turn of impellers and milk is under the effect of steam and impellers at the same time to get milk froth of high quality; secondly, the turn of impellers is drove by the wallop of steam of high pressure without auxiliary power unit, which can economize energy sources; thirdly, every parts of the automatism spumescence equipment of milk can be knock-down for its cleanout.

### BRIEF INTRODUCTION OF ATTACHED DRAWINGS

FIG. 1 is the sketch map of three-dimensional structure of the present utility model;

FIG. 2 is the explosion views of three-dimensional structure of the present utility model;

FIG. 3 is the cutaway view of the present utility model;

FIG. 4 is the cutaway view of the present utility model from tother angle.

### EMBODIMENT

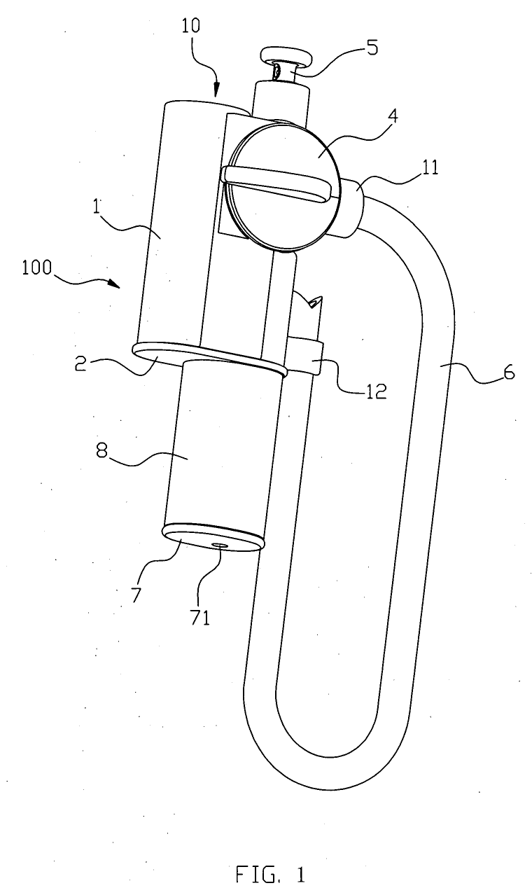

Referring to FIGS. 1 to 4, it is one embodiment of the present utility model.

Referring to FIG. 1, the automatism spumescence equipment of milk comprises a main body 100; the upside of the main body 100 has steam inlet 10 connecting with steam outlet of high pressure of coffee machine; the downside of the main body 100 has steam outlet 71; one side of the main body 100 has milk inlet 11 which connects with a tube 6 of silica gel. Outer lateral wall of the main body 100 has a pothook 12 for hanging of the tube 6 when the automatism spumescence equipment of milk is not in using. The main body 1 also has a knob 4 for controlling the flow of milk of milk inlet 11 and a release valve 5 for mixing air into milk.

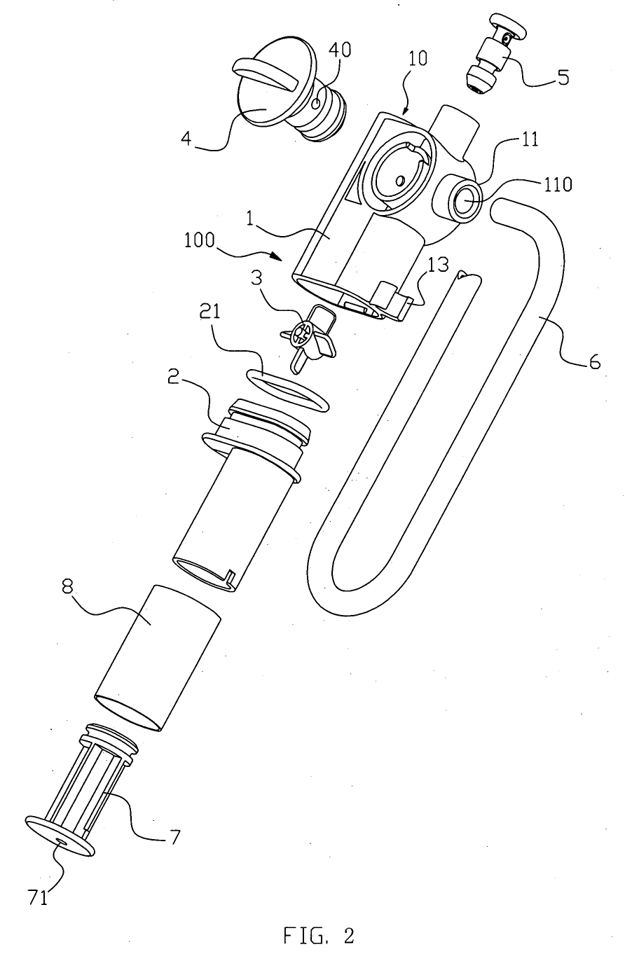

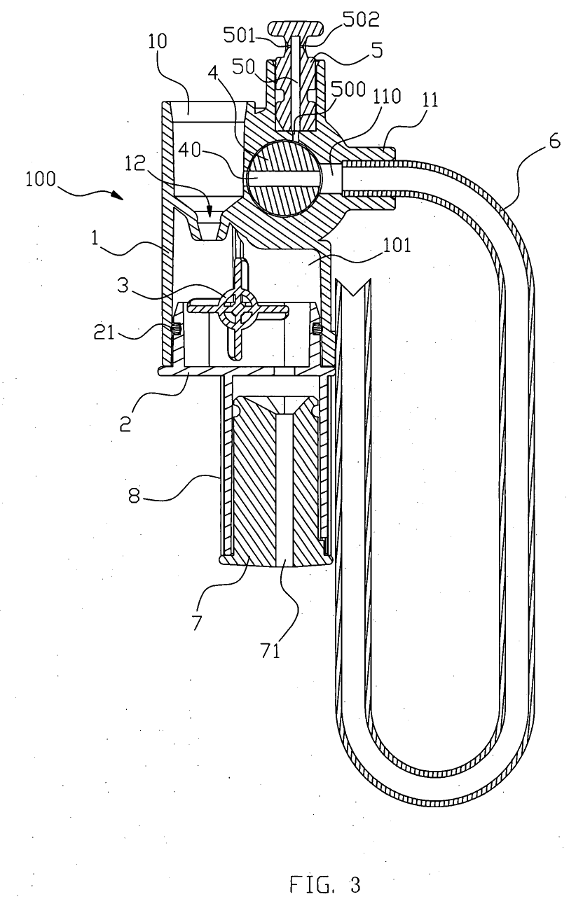

Referring to FIGS. 2 and 3, the main body 100 comprises a body 1 and a body base 2, the body base 2 embeds into the body 1 from downside to upside and fixedly connects with the body 1 by wedge-meet mode; a seal 21 locates between outer lateral wall of the body base 2 and the inner lateral wall of the body 1; the room surrounded by the body 1 and the body base 2 forms a sparkle cavity 101. The joint of the steam inlet 10 and the sparkle cavity 101 forms a taper inlet 12, whose external diameter is bigger than inner diameter so that steam and milk spout into the sparkle cavity 101 with some pressure. A body lid 7 is embedded into the body base 2; said steam outlet 71 forms on the body lid 7. A decoration covering 8 covers the body base 2.

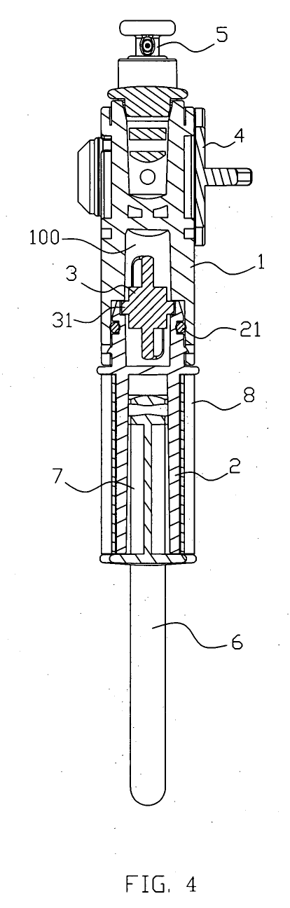

An impeller 3 locates inside of the sparkle cavity 101; the stress surfaces of the fan blades of the impeller 3 are towards the steam inlet 10; referring to FIG. 4, the rotor shaft 31 of the impeller 3 is rotatable sandwiched between the body 1 and the body base 2; said milk inlet 11 connects with the lateral wall of the steam inlet 10. Said knob 4 has a through hole 40 through the milk passage 110. It can adjust the quantity of inhalational milk by circumgyrating the knob 4 to make the through hole 40 of knob 4 have an angle with the milk passage 110.

The lateral wall of the milk passage 110 of milk inlet 11 has a breather hole 500; the breather hole 500 has a breather valve 5; the valve body of the breather valve 5 has a lengthways hole 50; one end of the lengthways hole 50 connects with the breather hole 500; two sides of another end of the lengthways hole 50 connects with outside by two through holes 501 and 502. Air can come into from through holes 501 and 502 of the breather valve 5 and mixes with milk and steam to make the quality of milk froth better.

Seals are set up between the body lid 7 and the body base 71, between the valve body of release valve 5 and the body 1, between the knob 4 and the body 1.

When steam of high pressure comes into from the steam inlet 10; milk is extracted from the tube 6 and comes into the sparkle cavity 101 with steam of high pressure through milk inlet 11 and steam inlet 10; the steam of high pressure drives impeller 3 wheel; milk comes into being milk froth of minuteness under the effect of the steam of high pressure and impeller 3 and bursts forth from steam outlet 71.

In addition, the body 1 can be transparent materials, the user can exteriorly become conscious of the course of sparkle in the sparkle cavity 101.

While the present utility model has been described in connection with what is considered the most practical and preferred embodiment, it is understood that present utility model is not limited to the disclosed embodiment but is intended to cover various arrangements included within the spirit and scope of the broadest interpretation so as to encompass all such modifications and equivalent arrangements.

1. Automatism spumescence equipment of milk, comprising: a main body having a sparkle cavity; two ends of the sparkle cavity respectively have a steam inlet and a steam outlet; an impeller is located inside the sparkle cavity; stress surfaces of the fan blades of the impellerface the steam inlet; a lateral wall of the steam inlet has a milk inlet; the milk inlet connects with a tube which can extract milk from a milk container.

2. The automatism spumescence equipment of milk according to claim 1, wherein a milk passage of said milk inlet has a knob which can turn outside of the main body; the knob has a through hole through the milk passage.

3. The automatism spumescence equipment of milk according to claim 1, wherein the lateral wall of the milk passage of said milk inlet has a breather hole; the breather hole has a breather valve; a valve body of the breather valve has a lengthways hole; one end of the lengthways hole connects with the breather hole; two sides of another end of the lengthways hole connects with the outside by two through holes.

4. The automatism spumescence equipment of milk according to claim 1, wherein the joint of the steam inlet and the sparkle cavity forms a taper inlet, whose external diameter is bigger than inner diameter.

5. The automatism spumescence equipment of milk according to claim 1, wherein said main body comprises a body and a body base; the body base is embedded into the body; space surrounded by the body and the body base forms said sparkle cavity; the rotor shaft of said impeller is rotatably sandwiched between the body and the body base; a body lid is embedded into the body base; said steam outlet forms on the body lid.
